(19) United States
(12) Patent Application Publication
(10) Pub. No.: US 2024/0079902 A1
(43) Pub. Date: Mar. 7, 2024

(54) ELECTRICITY CHARGE OUTPUT METHOD, ELECTRICITY CHARGE OUTPUT DEVICE, AND NON-TRANSITORY COMPUTER READABLE STORAGE MEDIUM

(71) Applicant: Panasonic Intellectual Property Corporation of America, Torrance, CA (US)

(72) Inventors: Ryota FUJIMURA, Kanagawa (JP); Ryuta HAMAMOTO, Tokyo (JP); Hiroki TAKEUCHI, Osaka (JP)

(73) Assignee: Panasonic Intellectual Property Corporation of America, Torrance, CA (US)

(21) Appl. No.: 18/388,742

(22) Filed: Nov. 10, 2023

Related U.S. Application Data
(63) Continuation of application No. PCT/JP2021/048601, filed on Dec. 27, 2021.

(30) Foreign Application Priority Data
May 13, 2021 (JP) 2021-081347

(51) Int. Cl. H02J 13/00

(52) U.S. Cl. CPC H02J 13/00002; H02J 13/00001

(57) ABSTRACT

An electricity charge output method includes, by a computer: acquiring a sum of electric energy usages, in a specified period, of a previously specified first device group among all devices provided at a facility and of a second device group that is among the all devices and is different from the first device group; acquiring an electric energy usage of the first device group in the specified period; reducing the sum in accordance with the electric energy usage of the first device group and calculating an electricity charge for the facility in the specified period, based on an electric energy after the reduction; and outputting information representing the electricity charge for the facility.

### FIELD OF INVENTION

The present disclosure relates to techniques for calculating an electricity charge.

### BACKGROUND ART

Conventionally, a method is known in which an electricity charge for a consumer's facility is calculated in accordance with an electric energy usage of an electrical device in the facility. For example, Patent Literature 1 discloses that an electricity charge is estimated on the basis of a plurality of types of electricity charge menus when the electricity charge menus are applied, the plurality of types of electricity charge menus representing electricity charges depending on the following: power consumption information of electrical devices; control contents of operation of electrical devices; and time slots. In addition, Patent Literature 2 discloses that cooperation money corresponding to an electric energy saved by a consumer in response to a power saving request is calculated on the basis of a power use history of the consumer.

However, by the techniques of Patent Literatures 1 and 2, it is impossible to flexibly calculate the electricity charge in accordance with the electric energy usage of a specific device among all devices provided in a facility of a consumer.
Patent Literature 1: Japanese Patent No. 6491815
Patent Literature 2: Japanese Patent Application Laid-Open No. 2016-126475

### SUMMARY OF THE INVENTION

The present disclosure has been made to solve the above problem, and an object of the present disclosure is to present an electricity charge output method, an electricity charge output device, and a non-transitory computer readable storage medium that are capable of flexibly calculating an electricity charge in accordance with an electric energy usage of a specific device among all devices provided in a facility of a consumer.

An electricity charge output method according to one aspect of the present disclosure includes, by a computer: acquiring a sum of electric energy usages, in a specified period, of a previously specified first device group among all devices provided at a facility and of a second device group that is among the all devices and is different from the first device group; acquiring an electric energy usage of the first device group in the specified period; reducing the sum in accordance with the electric energy usage of the first device group and calculating an electricity charge for the facility in the specified period, based on an electric energy after the reduction; and outputting information representing the electricity charge for the facility.

### BRIEF DESCRIPTION OF THE DRAWINGS

FIG. 1 is a block diagram illustrating an example of an overall configuration of an electricity charge calculation system.

FIG. 2 is a diagram illustrating an example of log information.

FIG. 3 is a diagram illustrating an example of an electricity charge calculation method by a calculation unit.

FIG. 4 is a diagram illustrating an example of a coefficient associated with a specified device.

FIG. 5 is a diagram illustrating an example of a table in which a coefficient is set.

FIG. 6 is a diagram illustrating an example of a coefficient adjustment method.

FIG. 7 is a diagram illustrating an example of a coefficient adjustment method.

FIG. 8 is a flowchart illustrating an example of an electricity charge output process.

FIG. 9 is a diagram illustrating an example of a discount detail screen.

### DETAILED DESCRIPTION

(Background to the Present Disclosure)

The present inventor is considering to provide a service in which, in an electricity retail business, an electricity charge can be flexibly set in accordance with an operation state of a specific electrical device, for example, an electricity charge is made free for a home electric appliance of a company's own product. However, in the conventional electricity charge calculation methods described in Patent Literatures 1 and 2 and the like, the electricity charge corresponding to the sum of the electric energy usage of all the electrical devices provided in the facility of the consumer is calculated, but an electricity charge corresponding to the electric energy usage of each electrical device is not individually calculated.

For this reason, the conventional electricity charge calculation methods described in Patent Literatures 1 and 2, and the like have a problem that the electricity charge cannot be flexibly calculated in accordance with the electric energy usage of a specific device among all the devices provided in the facility of the consumer. Therefore, the present inventor has intensively studied a technique for flexibly calculating an electricity charge in accordance with an electric energy usage of a specific device among all the devices provided in a facility of a consumer, and has conceived each aspect of the present disclosure described below.

An electricity charge output method according to one aspect of the present disclosure includes, by a computer: acquiring a sum of electric energy usages, in a specified period, of a previously specified first device group among all devices provided at a facility and of a second device group that is among the all devices and is different from the first device group; acquiring an electric energy usage of the first device group in the specified period; reducing the sum in accordance with the electric energy usage of the first device group and calculating an electricity charge for the facility in the specified period, based on an electric energy after the reduction; and outputting information representing the electricity charge for the facility.

With the present configuration, the electricity charge for the facility in the specified period is calculated based on the electric energy after the sum of the electric energy usage of all the devices provided in the facility in the specified period is reduced in accordance with the electric energy usage of the previously specified first device group.

Therefore, the present configuration can calculate the electricity charge that is obtained by reducing, in according with the electric energy usage of a first device group in a specified period, the electricity charge for the facility of the consumer in the specified period calculated based on the sum as in the conventional manner. Therefore, the present configuration can flexibly calculate the electricity charge in accordance with the electric energy usage of a specific device among all the devices provided in the facility of the consumer.

In the above electricity charge output method, in the reducing the sum, a product of the electric energy usage of the first device group and a coefficient previously associated with the first device group may be reduced from the sum.

With the present configuration, the product of the electric energy usage of the first device group in the specified period and the coefficient previously associated with the first device group is reduced from the sum, and the electricity charge for the facility in the specified period is calculated based on an electric energy after the reduction. Therefore, it is possible to reduce, in accordance with the product of the electric energy usage of the first device group in the specified period and the coefficient previously associated with the first device group, the electricity charge for the facility of the consumer in the specified period calculated based on the sum as in the conventional manner.

In the above electricity charge output method, the coefficient may be determined depending on a type of the first device group.

With the present configuration, the product of the electric energy usage of the first device group in the specified period and the coefficient previously determined depending on the type of the first device group is reduced from the sum, and the electricity charge for the facility in the specified period is calculated based on an electric energy after the reduction. Therefore, it is possible to reduce, depending on the type of the first device group, the electricity charge for the facility of the consumer in the specified period calculated based on the sum as in the conventional manner.

In the above electricity charge output method, the coefficient may be determined depending on an operation state of the first device group in the specified period.

With the present configuration, the product of the electric energy usage of the first device group in the specified period and the coefficient determined depending on the operation state of the first device group in the specified period is reduced from the sum, and the electricity charge for the facility in the specified period is calculated based on an electric energy after the reduction. Therefore, it is possible to reduce, depending on the operation state of the first device group in the specified period, the electricity charge for the facility of the consumer in the specified period calculated based on the sum as in the conventional manner.

In the above electricity charge output method, the first device group may include an air conditioner, and the method may further include, by the computer: acquiring information representing outside air temperature in the specified period, and adjusting the coefficient associated with the air conditioner in accordance with the acquired outside air temperature.

With the present configuration, the product of the electric energy usage of the air conditioner in the specified period and the coefficient previously adjusted depending on the outside air temperature in the specified period is reduced from the sum, and the electricity charge for the facility in the specified period is calculated based on the electric energy after the reduction. Therefore, it is possible to reduce, depending on the outside air temperature in the specified period, the electricity charge for the facility of the consumer in the specified period calculated based on the sum as in the conventional manner.

The above electricity charge output method may further include, by the computer: acquiring information representing whether there was a person in the specified period in a room in which the first device group is provided; and adjusting the coefficient depending on whether the information representing that there was a person in the room has been acquired.

With the present configuration, the product of the electric energy usage of the first device group in the specified period and the coefficient adjusted depending on whether there was a person in the specified period in the room in which the first device group is provided is reduced from the sum, and the electricity charge for the facility in the specified period is calculated based on the electric energy after the reduction. Therefore, it is possible to reduce, depending on whether there was a person in the specified period in the room in which the first device group is provided, the electricity charge for the facility of the consumer in the specified period calculated based on the sum as in the conventional manner.

The above electricity charge output method may further include, by the computer: detecting whether a plurality of devices, of an identical type, included in the first device group simultaneously operated in the specified period; and adjusting the coefficient associated with each of the plurality of devices of the identical type when detection is made that the plurality of devices of the identical type simultaneously operated.

With the present configuration, when the plurality of devices, of the identical type, included in the first device group simultaneously operated in the specified period, the product of the electric energy usage of the plurality of devices of the identical type in the specified period and the adjusted coefficient associated with the plurality of devices of the identical type is reduced from the sum. Then, the electricity charge for the facility in the specified period is calculated based on the electric energy after the reduction. Therefore, it is possible to adjust, depending on whether the plurality of devices, of the identical type, included in the first device group simultaneously operated in the specified period, the electricity charge that will be reduced from the electricity charge for the facility of the consumer in the specified period calculated based on the sum as in the conventional manner.

The above electricity charge output method may further include, by the computer: acquiring information representing an operating time of the first device group in the specified period; and adjusting the coefficient in accordance with the operating time.

With the present configuration, the product of the electric energy usage of the first device group in the specified period and the coefficient adjusted depending on the operating time of the first device group in the specified period is reduced from the sum, and the electricity charge for the facility in the specified period is calculated based on the electric energy after the reduction. Therefore, it is possible to reduce, depending on the operating time of the first device group in the specified period, the electricity charge for the facility of the consumer in the specified period calculated based on the sum as in the conventional manner.

The above electricity charge output method may further include, by the computer, adjusting the coefficient in accordance with a number of previously designated one or more devices included in the first device group.

With the present configuration, the product of the electric energy usage of the first device group in the specified period and the coefficient adjusted in accordance with the number of the previously designated one or more devices included in the first device group is reduced from the sum, and the electricity charge for the facility in the specified period is calculated based on the electric energy after the reduction. Therefore, it is possible to reduce, in accordance with the number of the previously designated one or more devices included in the first device group, the electricity charge for the facility of the consumer in the specified period calculated based on the sum as in the conventional manner.

The above electricity charge output method may further include, by the computer: acquiring, from the facility, first information on a user of the first device group and second information representing a use history of the first device group; and adjusting the coefficient, based on one or more of an acquisition amount of the first information, an acquisition amount of the second information, a content of the first information, and a content of the second information.

With the present configuration, the product of the electric energy usage of the first device group in the specified period and the coefficient adjusted based on one or more of the acquisition amount of the first information, the acquisition amount of the second information, the content of the first information, and the content of the second information is reduced from the sum, and the electricity charge for the facility in the specified period is calculated based on the electric energy after the reduction. Therefore, it is possible to reduce, based on one or more of the acquisition amount of the first information, the acquisition amount of the second information, the content of the first information, and the content of the second information, the electricity charge for the facility of the consumer in the specified period calculated based on the sum as in the conventional manner.

The above electricity charge output method may further include, by the computer, outputting information representing the coefficient to be displayed on a display.

With the present configuration, the information representing the coefficient previously associated with the first device group is displayed on the display so that a user can visually recognize the coefficient previously associated with the first device group.

The above electricity charge output method may further include, by the computer, outputting information representing a time series change, in the coefficient, in the specified period to be displayed on a display.

With the present configuration, the information representing the time series change, in the specified period, in the coefficient previously associated with the first device group is displayed on the display so that the user can visually recognize the time series change, in the specified period, in the coefficient previously associated with the first device group.

The above electricity charge output method may further include, by the computer, outputting information representing how the coefficient is determined, the information being to be displayed on the display in association with the time series change in the coefficient.

With the present configuration, when the information representing the time series change, in the coefficient, in the specified period previously associated with the first device group is displayed on the display, it is possible to make the user visually recognize how the coefficient is determined, in association with the time series change in the coefficient.

An electricity charge output device according to another aspect of the present disclosure includes: a first acquisition unit that acquires a sum of electric energy usages, in a specified period, of a previously specified first device group among all devices provided at a facility and of a second device group that is among the all devices and is different from the first device group; a second acquisition unit that acquires an electric energy usage of the first device group in the specified period; a calculation unit that reduces the sum in accordance with the electric energy usage of the first device group and calculates an electricity charge for the facility in the specified period, based on an electric energy after the reduction; and an output unit that outputs information representing the electricity charge for the facility.

A non-transitory computer readable storage medium according to another aspect of the present disclosure is a non-transitory computer readable storage medium storing a program causing a computer to function as: a first acquisition unit that acquires a sum of electric energy usages, in a specified period, of a previously specified first device group among all devices provided at a facility and of a second device group that is among the all devices and is different from the first device group; a second acquisition unit that acquires an electric energy usage of the first device group in the specified period; a calculation unit that reduces the sum in accordance with the electric energy usage of the first device group and calculates an electricity charge for the facility in the specified period, based on an electric energy after the reduction; and an output unit that outputs information representing the electricity charge for the facility.

The present configuration can provide effects similar to those of the above electricity charge output method.

The present disclosure can be realized also as a system that operates by such a program. In addition, it goes without saying that such a computer program can be distributed via a computer-readable non-transitory recording medium such as a CD-ROM or via a communication network such as the Internet.

Note that each of the embodiments described below describes a specific example of the present disclosure. The numerical values, shapes, components, steps, order of steps, and the like shown in the following embodiments are each merely an example, and are not intended to limit the present disclosure. Further, among the components in the following embodiments, components that are not described in independent claims indicating the highest concepts are described as arbitrary components. Further, in all the embodiments, the respective contents can be combined.

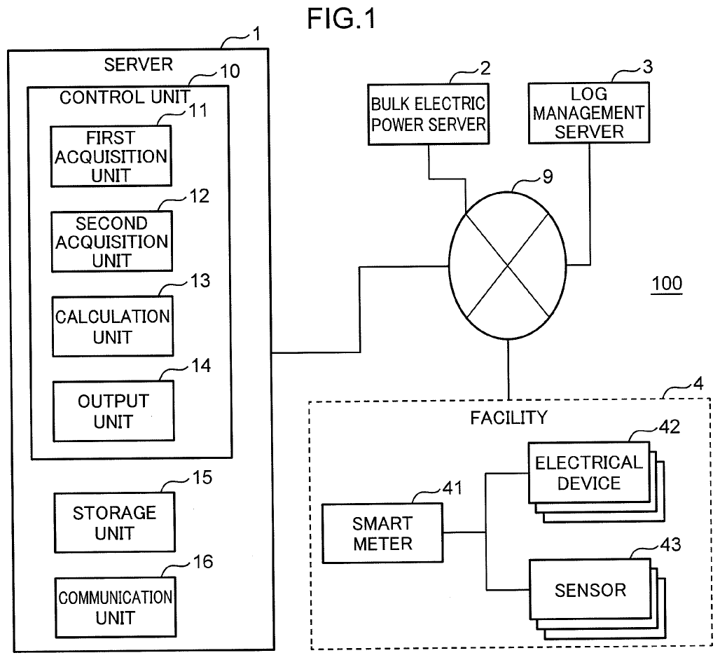

Embodiments of the present disclosure will be described below with reference to the drawings. FIG. 1 is a diagram illustrating an example of an overall configuration of an electricity charge calculation system 100. The electricity charge calculation system 100 is a system that calculates an electricity charge in a specified period for a facility 4 of a consumer.

Specifically, as illustrated in FIG. 1, the electricity charge calculation system 100 includes one or more electrical devices 42 and sensors 43 provided in a consumer's facility 4, a smart meter 41 provided in the consumer's facility 4, a bulk electric power server 2, a log management server 3, and a server 1. The electrical devices 42 and the sensors 43 are also written as devices, and the server 1 is also written as an electricity charge output device. These components included in the electricity charge calculation system 100 communicate with each other via a communication network 9 such as the Internet.

The electrical device 42 operates by electric power supplied to the facility 4 of the consumer. The facility 4 includes collective housing such as condominiums and apartment houses and detached houses. In addition, the facility 4 includes offices, factories, and the like. The facility 4 means a facility owned or used by a consumer. The consumer includes a user who owns the electrical devices 42 and the sensors 43 or a user who uses the electrical devices 42 and the sensors 43. Examples of the electrical devices 42 include an air conditioner, a television set, an audio device, a lighting fixture, a refrigerator, a washing machine, a vacuum cleaner, an induction cooker, a rice cooker, a microwave oven, a dishwasher, and a personal computer. The electrical devices 42 each periodically (for example, every 5 minutes) transmit log information representing its own operation state to the log management server 3.

The sensors 43 operate by electric power supplied to the facility 4 of the consumer. The sensors 43 includes, for example, a human sensor that detects presence or absence of a person in a room, a temperature sensor that detects the temperature inside or outside of a room, and a humidity sensor that detects the humidity inside or outside of a room. The sensors 43 each periodically (for example, every 5 minutes) transmit log information representing its own operation state to the log management server 3.

The smart meter 41 measures, every predetermined unit time, the sum of the electric energy usages of all the electrical devices 42 and the sensors 43 provided in the consumer's facility 4 for each unit time (hereinafter, the sum is referred to as a bulk electric energy). The smart meter 41 transmits the information representing the measured bulk electric energy (hereinafter, the information is referred to as bulk electric power information) to the bulk electric power server 2. Note that the smart meter 41 may transmit the bulk electric power information every time the bulk electric energy is measured, or may collectively transmit the untransmitted bulk electric power information at a predetermined timing, for example, once a day.

The bulk electric power server 2 receives the bulk electric power information from the smart meters 41 provided in the respective facilities 4 of a plurality of consumers, and manages the received bulk electric power information. The bulk electric power server 2 returns to the server 1 the bulk electric power information requested by the server 1. In addition, the bulk electric power server 2 manages information representing an electricity charge per unit electric energy (hereinafter, the electricity charge is referred to as a unit charge) for each time slot (herein after, the information is referred to as unit charge information). When the bulk electric power server 2 is requested by the server 1 to transmit the unit charge information, the bulk electric power server 2 returns the unit charge information to the server 1.

The log management server 3 receives log information from the one or more electrical devices 42 and sensors 43 provided in each of the facilities 4 of a plurality of consumers, and manages the received log information. The log information includes: a time stamp representing a date and time when each of the electrical devices 42 and the sensors 43 transmits log information; identification information of each of the electrical devices 42 and the sensors 43; state information indicating an operation state of each of the electrical devices 42 and the sensors 43; and the like.

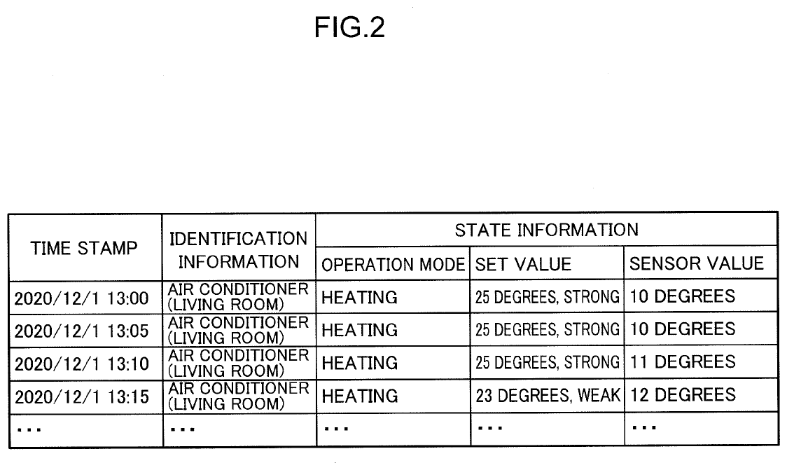

FIG. 2 is a diagram illustrating an example of log information. For example, FIG. 2 illustrates an example of log information transmitted every five minutes from 13:00 on Dec. 1, 2020 by an air conditioner provided in a living room. The state information representing the operation state of the air conditioner includes an operation mode, a set value, and a sensor value.

For example, the state information included in the log information transmitted at 13:00 on Dec. 1, 2020 illustrated in FIG. 2 shows that the operation mode is “heating”, the set value is “25 degrees, strong”, and the sensor value is “10 degrees”. The state information shows that the operation state, of the air conditioner provided in the living room at 13:00 on Dec. 1, 2020, is a state where the heating operation is performed with a set temperature of 25 degrees and a strong wind, and the outside air temperature detected by an outside air temperature sensor of the air conditioner is 10 degrees.

Note that the state information is not limited to the example of FIG. 2, and may appropriately include information necessary to represent the operation states of the electrical devices 42 and the sensors 43. For example, the state information may include an electric energy usage, of one of electrical devices 42, detected by power a sensor included in the electrical device 42. The state information may include information that is detected by a human sensor and represents whether there was a person in the room where the human sensor is provided. The state information may include information that is detected by a human sensor included in one of the electrical devices 42 and represents whether there was a person in the room where the electrical device 42 is provided.

In the example of FIG. 2, the identification information of the air conditioner provided in the living room is the character string “air conditioner (living room)”, but the identification information of the electrical devices 42 and the sensors 43 may be any information that uniquely identifies the electrical devices 42 and the sensors 43 in the facility 4. For example, the identification information of each of the electrical devices 42 and the sensors 43 may be a serial number, a product model number, information indicating the room in which the electrical device 42 or sensor 43 is provided (for example, “IF south”), or a combination of one or more of these pieces of information.

The one or more electrical devices 42 and sensors 43 provided in the consumer's facility 4 are classified into a first device group (hereinafter, specified devices) previously specified and a second device group different from the specified devices. The server 1 calculates the electricity charge for the facility 4 on the basis of not only the bulk electric energy, which is the sum of the electric energy usages of all the electrical devices 42 and the sensors 43 provided in the facility 4 of the consumer but also the electric energy usages of the specified devices. The first device group and the second device group may include a plurality of devices or at least one device.

In the present embodiment, examples of the specified devices include an electrical device 42 and a sensor 43 that are provided in the facility 4 of the consumer and manufactured by a specific manufacturer. However, the specified devices are not limited thereto, and may be, for example, an electrical device 42, a sensor 43, and the like purchased during a predetermined campaign period. Alternatively, the specified devices include a device specified by a third party other than the consumer. Examples of the third party include a device manufacturer, an electric power company, and the like.

Specifically, the server 1 is configured with one server device or a cloud server. The server 1 includes a storage unit 15, a communication unit 16, and a control unit 10.

The storage unit 15 is configured with a storage device such as a hard disk drive (HDD) or a solid state drive (SSD). The storage unit 15 stores various types of information necessary to calculate the electricity charge on the basis of information and the like replied by mail, e-mail, a website, or the like from the consumer to a questionnaire.

For example, the storage unit 15 stores identification information on the one or more electrical devices 42 and sensors 43 provided in the consumer's facility 4 and device information related to the one or more electrical devices 42 and sensors 43, in association with each other. The device information includes, for example, types (for example, air conditioner) of the electrical devices 42 and the sensors 43, and identification information of manufacturers of the electrical devices 42 and the sensors 43. In addition, the device information may further include date and time of purchase of the electrical devices 42 and the sensors 43, identification information of a room in which the electrical devices 42 and the sensors 43 are provided, and other information. Therefore, the server 1 can identify the specified devices from among the one or more electrical devices 42 and the sensors 43 on the basis of the information included in the device information stored in the storage unit 15.

In addition, the storage unit 15 stores, in association with the state information indicating the operation states of the electrical devices 42 and the sensors 43 (FIG. 2), the information representing electric energies necessary for the electrical devices 42 and the sensors 43 to continue the operation states (hereinafter, referred to as necessary electric energies) for a time corresponding to the transmission interval (for example, 5 minutes) of the log information.

In addition, the storage unit 15 may store personal information related to the consumer. The personal information related to the consumer includes, for example, identification information of the consumer, communication destination information, information representing an address, a telephone number, or a family structure. The communication destination information of the consumer is information representing a destination when information is transmitted to the consumer. For example, the communication destination information of the consumer includes a mail address of the consumer and account names of various social network systems (SNSs) of the consumer.

The communication unit 16 is configured using a communication circuit compatible with an arbitrary communication system such as Ethernet (registered trademark). The communication unit 16 communicates with external devices such as the bulk electric power server 2, the log management server 3, and the like via the communication network 9.

The control unit 10 includes a microcomputer (computer) including a central processing unit (CPU), a random-access memory (RAM), a read-only memory (ROM), and the like. The control unit 10 includes a first acquisition unit 11, a second acquisition unit 12, a calculation unit 13, and an output unit 14. The first acquisition unit 11 to the output unit 14 are realized, for example, by the CPU executing a predetermined control program (program).

The first acquisition unit 11 acquires the sum of the electric energy usages in the specified period of the one or more electrical devices 42 and sensors 43 provided in the facility 4. For example, the specified period is set to be longer than the measurement interval at which the smart meter 41 measures the bulk electric energy. The specified period may be, for example, one day or one month. Hereinafter, for convenience of description, the sum of the electric energy usages in the specified period of the one or more electrical devices 42 and the sensors 43 provided in the facility 4 is simply written as the bulk electric energy in the specified period.

Specifically, the first acquisition unit 11 controls the communication unit 16 and requests the bulk electric power server 2 to transmit bulk electric energy information representing the bulk electric energy in the specified period. Then, the first acquisition unit 11 acquires the bulk electric energy information returned from the bulk electric power server 2 in response to the request.

The second acquisition unit 12 acquires the electric energy usages of the specified devices provided in the facility 4 in the specified period.

Specifically, the second acquisition unit 12 controls the communication unit 16 and requests the log management server 3 to transmit the log information representing the operation states of the specified devices in the specified period. In response to the request, the log management server 3 returns one or more pieces of log information each including: a time stamp representing a date and time included in the specified period; and the identification information of the specified devices. With respect to each of the one or more pieces of returned log information, the second acquisition unit 12 refers, from the storage unit 15, to the information representing the necessary electric energy associated with the state information included in each piece of log information. The second acquisition unit 12 acquires the necessary electric energies as the electric energy usages of the specified devices that have transmitted the respective pieces of log information.

Note that if the electric energy usage of one of the specified devices is included in the state information included in the log information acquired from the log management server 3, the second acquisition unit 12 may acquire, as the electric energy usage of the specified device that has transmitted the log information, the electric energy usage of the specified device included in the state information.

In addition, it is assumed that the bulk electric power server 2 can acquire, using a machine-learned model or the like, the electric energy usages of the specified devices included in the bulk electric energy represented by each piece of bulk electric power information managed by the bulk electric power server 2. In this case, the second acquisition unit 12 may be configured as follows. The second acquisition unit 12 requests the bulk electric power server 2 to transmit information representing the electric energy usages of the specified devices in the specified period, and the second acquisition unit 12 acquires the information representing the electric energy usages of the specified devices in the specified period, the information being returned from the bulk electric power server 2 in response to the request.

The calculation unit 13 calculates the electricity charge for the facility 4 in the specified period.

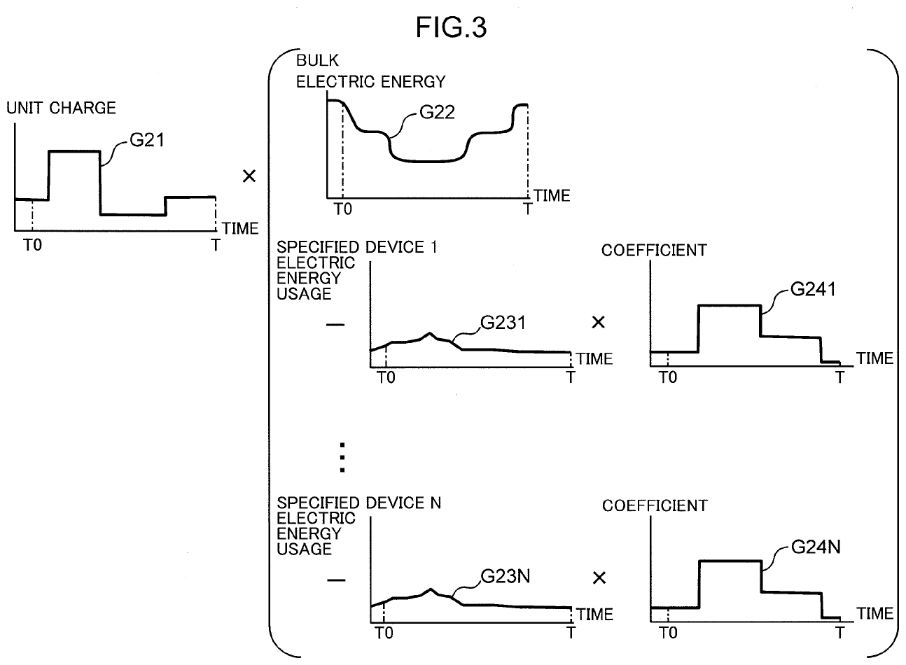

FIG. 3 is a diagram illustrating an example of an electricity charge calculation method by the calculation unit 13. The graph G21 in FIG. 3 represents a unit charge for each time slot in a specified period T. The graph G22 in FIG. 3 represents a time series change in the bulk electric energy for each unit time T0 in the specified period T. The graph G231 in FIG. 3 represents a time series change in the bulk electric energy of a first specified device for each unit time T0 in the specified period T, and the graph G241 in FIG. 3 represents a time series change in the coefficient associated with the first specified device for each unit time T0 in the specified period T. The graph G23N in FIG. 3 represents a time series change in the bulk electric energy of an Nth specified device for each unit time T0 in the specified period T, and the graph G24N in FIG. 3 represents a time series change in the coefficient associated with the Nth specified device for each unit time T0 in the specified period T. Note that the number N represents the number of the specified devices.

Specifically, the calculation unit 13 controls the communication unit 16 and requests the bulk electric power server 2 to transmit the unit charge information (graph G21) representing the unit charge for each time slot in the specified period T. Then, the calculation unit 13 acquires the unit charge information returned from the bulk electric power server 2 in response to the request.

For each of one or more consecutive unit times T0 constituting the specified period T, the calculation unit 13 reduces the bulk electric energy for each unit time T0 (graph G22) acquired by the first acquisition unit 11 in accordance with the electric energy usage of each of the first to Nth specified devices for each unit time T0 (graphs G231 to G23N) acquired by the second acquisition unit 12.

In detail, as illustrated on the right side of FIG. 3, for each of the one or more consecutive unit times T0 included in the specified period T, the calculation unit 13 calculates the product of the electric energy usage of each of the first to Nth specified devices for each unit time T0 (graphs G231 to G23N) acquired by the second acquisition unit 12 and the coefficient (graphs G241 to G24N) previously associated with each of the first to Nth specified devices. Then, by the calculation unit 13, the product calculated for each unit time T0 is reduced from the hulk electric energy for each unit time T0 (graph G22) acquired by the first acquisition unit 11.

Then, for each of the one or more consecutive unit times T0 included in the specified period T, the calculation unit 13 calculates, as the electricity charge for the facility 4 for each unit time T0, the product of the electric energy after the reduction for each unit time T0 and the electricity charge (graph G21) per unit electric energy in the time slot including each unit time T0. Then, the calculation unit 13 calculates, as the electricity charge for the facility 4 in the specified period T, the sum of the electricity charges calculated for respective ones of the one or more consecutive unit times T0 included in the specified period T.

The output unit 14 outputs information (hereinafter, referred to as electricity charge information) representing the electricity charge for the facility 4 to be displayed on the display. Specifically, the electricity charge information includes screen data representing a screen including the electricity charge, for the facility 4 in the specified period, calculated by the calculation unit 13. The screen data is configured in a format that can be displayed on a display, for example, in the hypertext markup language (HTML).

The output unit 14 controls the communication unit 16 and transmits the electricity charge information to the destination represented by the communication destination information of the consumer stored in the storage unit 15, via the communication network 9. As a result, the consumer can receive the information, output by the output unit 14, representing the electricity charge for the facility 4 in the specified period, by the information processing device such as a personal computer, a smartphone, or a tablet terminal, and the consumer can display the received information on the display.

Next, the coefficients associated with the specified devices will be described in detail. The coefficient associated with each of the specified devices is determined in accordance with the type of the specified device and is previously stored in the storage unit 15.

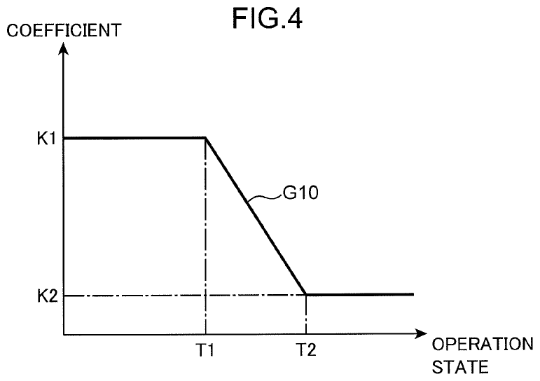

FIG. 4 is a diagram illustrating an example of the coefficient associated with one of the specified devices. In FIG. 4, the horizontal axis represents the operation state of the specified device in a specified period, and the vertical axis represents the coefficient. A graph G10 in FIG. 4 indicates the coefficient associated with the specified device whose type is air conditioner. The graph G10 illustrates an example in which the coefficient is set to “K1” when the operation state of the specified device in the specified period indicates a set temperature less than or equal to “T1”. In addition, the graph G10 illustrates an example when the operation state of the specified device indicates a set temperature higher than “T1” and less than or equal to “T2” in the specified period. In the example, the coefficient is set lower within the range from “K1” to “K2”, as the set temperature is higher. Further, the graph G10 illustrates an example in which the coefficient is set to “K2” when the operation state of the air conditioner in the specified period indicates a set temperature higher than “T2”.

In a similar manner, for example, the coefficient associated with one of the specified devices whose type is television set and lighting fixture may be determined. Specifically, the coefficient may be determined depending on the operation state of a television set and a lighting fixture in the specified period as follows. When the luminance of the television set and the lighting fixture indicates a luminance less than or equal to “T1”, the coefficient is set to “K1”; when the operation state indicates a luminance higher than “T1” and less than or equal to “T2”, the coefficient is set lower within the range from “K1” to “K2” as the luminance is higher; and when the operation state indicates a luminance higher than “T2”, the coefficient is set to “K2”.

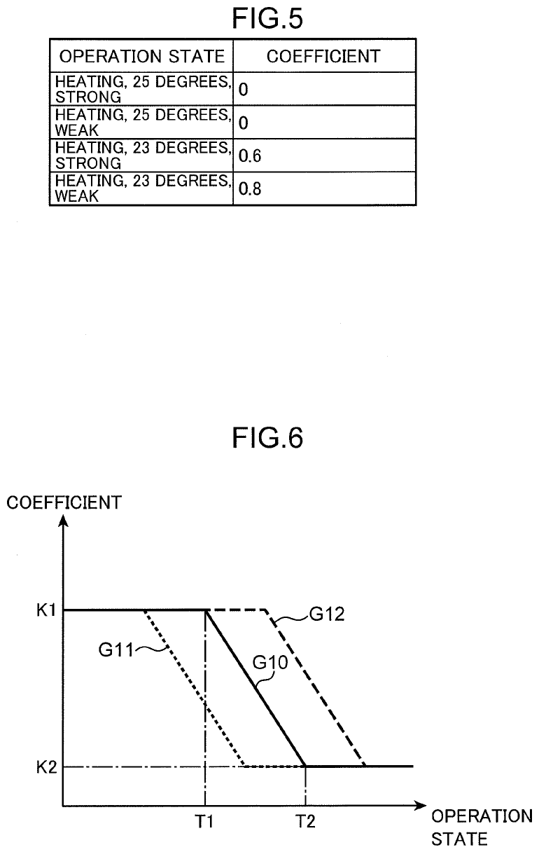

The coefficients associated with the specified devices are not limited thereto, and a table in which an operation state and a coefficient are associated with each other as illustrated in FIG. 5 may be previously stored in the storage unit 15, and the coefficient may be determined using the table. FIG. 5 illustrates a table in which the operation state of an air conditioner is associated with the coefficient associated with one of the specified devices whose type is air conditioner. For example, the coefficient may be set to “0.6” by using the table illustrated in FIG. 5 in a case where the operation state of the air conditioner in the specified period is the state “heating, 23 degrees, strong”, in which the heating operation is being performed with the set temperature of 23 degrees and a strong wind.

When the specified devices include an air conditioner, the calculation unit 13 may acquire an outside air temperature from the state information (FIG. 2) that is included in the log information of the air conditioner and is acquired by the second acquisition unit 12. Then, the calculation unit 13 may adjust the coefficient (FIGS. 4 and 5) associated with the air conditioner in accordance with the acquired outside air temperature. In the following description, the adjustment of the coefficient by the calculation unit 13 will be referred to as first adjustment.

FIG. 6 is a diagram illustrating an example of a coefficient adjustment method. In FIG. 6, the horizontal axis represents the operation state of one of the specified devices in a specified period, and the vertical axis represents the coefficient. The graph G10 in FIG. 6 is the same graph as the graph G10 in FIG. 4, and represents the coefficient associated with the specified device whose type is air conditioner. For example, as illustrated in FIG. 6, the calculation unit 13 may shift the graph G10 further leftward as the acquired outside air temperature is higher than a predetermined temperature (for example, 24 degrees) so that the coefficient associated with the air conditioner is adjusted to the coefficient represented by the shifted graph G11. On the other hand, the calculation unit 13 may shift the graph G10 further rightward as the acquired outside air temperature is lower than the predetermined temperature so that the coefficient associated with the air conditioner is adjusted to the coefficient represented by the shifted graph G12.

However, the calculation unit 13 is not limited thereto. For example, by shifting the graph G10 further downward as the acquired outside air temperature is higher than a predetermined temperature and by shifting the graph G10 further upward as the acquired outside air temperature is lower than the predetermined temperature, the calculation unit 13 may adjust the coefficient associated with the air conditioner to the coefficient represented by the shifted graph.

By the first adjustment, the coefficient associated with the air conditioner is adjusted to be lower as the outside air temperature is higher than the predetermined temperature. Therefore, as the outside air temperature is higher than the predetermined temperature, the electric energy to be reduced from the bulk electric energy is reduced, and the electricity charge to be deducted becomes accordingly low. As a result, in a case where the outside air temperature is higher than the predetermined temperature, it is possible to prevent or reduce the chance of the consumer using the air conditioner with a high set temperature and thus unnecessarily consuming electric power.

Further, it is assumed that the state information included in the log information acquired by the second acquisition unit 12 includes information that is detected by a human sensor included in one of the specified devices and that represents whether there was a person in the room in which the specified device is provided. In this case, the calculation unit 13 may acquire the information representing whether there was a person in the room, from the state information included in the log information acquired by the second acquisition unit 12. Then, the calculation unit 13 may adjust the coefficient associated with the specified device, depending on whether the information indicating that there was a person in the room in which the specified device is provided has been acquired. In the following description, the adjustment of the coefficient by the calculation unit 13 will be referred to as second adjustment.

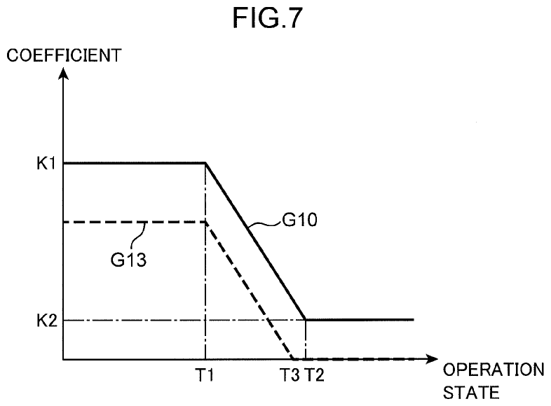

FIG. 7 is a diagram illustrating an example of the coefficient adjustment method. In FIG. 7, the horizontal axis represents the operation state of the specified device in the specified period, and the vertical axis represents the coefficient. The graph G10 in FIG. 7 is the same graph as the graph G10 in FIG. 4, and represents the coefficient associated with the specified device whose type is air conditioner. For example, as illustrated in FIG. 7, when the calculation unit 13 has acquired the information indicating that there is no person in the room in which the air conditioner is provided, from the state information included in the log information of the air conditioner, the calculation unit 13 shifts the graph G10 downward, thereby adjusting the coefficient associated with the air conditioner to the coefficient represented by the shifted graph G13.

Note that the calculation unit 13 is not limited thereto. For example, when having acquired information indicating that there is no person in the room where the air conditioner is provided, the calculation unit 13 may shift the graph G10 leftward as illustrated in FIG. 6 to adjust the coefficient associated with the air conditioner to the coefficient represented by the shifted graph G11.

On the other hand, when the calculation unit 13 has acquired, from the state information included in the log information of the air conditioner, information indicating that there is a person in the room in which the air conditioner is provided, the calculation unit 13 does not adjust the coefficient associated with the air conditioner.

Further, it is assumed that the state information (FIG. 2) included in the log information acquired by the second acquisition unit 12 includes information representing whether there was a person in the room in which the human sensor is provided. Also in this case, in a similar manner to the above, depending on whether the calculation unit 13 acquired, from the state information included in the log information acquired by the second acquisition unit 12, the information representing whether there was a person in the room in which the human sensor is provided, the calculation unit 13 may adjust the coefficient associated with the specified device provided in the same room as the human sensor is provided.

In this case, the calculation unit 13 only has to identify, on the basis of the information stored in the storage unit 15, the specified device provided in the same room as the human sensor is provided. Specifically, from the device information that is associated, in the storage unit 15, with the identification information of the human sensor, the calculation unit 13 only has to acquire the identification information of the room in which the human sensor is provided. Then, the calculation unit 13 only has to identify the identification information of the specified device associated, in the storage unit 15, with the device information including the identification information of the room as the identification information of the specified device provided in the same room as the human sensor is provided.

By the second adjustment, the coefficient associated with the specified device is adjusted to be lower when there is no person in the room in which the specified device is provided than when there is a person in the room in which the specified device is provided. As a result, when there is no person in the room in which the specified device is provided, the electric energy to be reduced from the bulk electric energy is reduced as compared with when there is a person in the room in which the specified device is provided, and the electricity charge to be deducted becomes accordingly low. As a result, it is possible to prevent or reduce the chance of the consumer using the specified device in the room in which there is no person, and it is possible to prompt the consumer to save electricity in the room in which there is no person.

In addition, the calculation unit 13 may operate as follows. The calculation unit 13 detects whether a plurality of devices of the identical type included in the specified devices simultaneously operated in the specified period, and when it is detected that a plurality of devices of the identical type simultaneously operated, the calculation unit 13 adjusts the coefficients each associated with one of the plurality of devices of the identical type. In the following description, the adjustment of the coefficients by the calculation unit 13 will be referred to as third adjustment.

Specifically, the calculation unit 13 may detect whether a plurality of devices of the identical type included in the specified devices simultaneously operated, by referring to one or more pieces of log information that are acquired by the second acquisition unit 12 from the log management server 3 and that each include: a time stamp representing a date and time included in the specified period; and identification information of one of the specified devices, and by referring to the device information stored in the storage unit 15. Then, when the calculation unit 13 detects that a plurality of devices of the identical type simultaneously operated, the calculation unit 13 may divide the coefficients each associated with one of the plurality of devices of the identical type by the number of the plurality of devices of the identical type. Then, the calculation unit 13 may use the result of the division as an adjusted coefficient associated with each of the plurality of devices of the identical type.

By the third adjustment, as the number of the plurality of specified devices of the identical type simultaneously operating in the specified period is larger, the electric energy to be reduced from the bulk electric energy is reduced more, and the electricity charge to be deducted becomes accordingly low. As a result, it is possible to prevent or reduce the change of the consumer causing a plurality of specified devices of the identical type to operate simultaneously.

Furthermore, the calculation unit 13 may acquire information representing the operating time of one of the specified devices in the specified period and may adjust the coefficient associated with the specified device in association with the acquired operating time. In the following description, the adjustment of the coefficient by the calculation unit 13 will be referred to as fourth adjustment.

Specifically, the calculation unit 13 refers to one or more pieces of log information that are acquired by the second acquisition unit 12 from the log management server 3 and that each include: a time stamp representing a date and time included in the specified period; and identification information of one of the specified devices, and the calculation unit 13 acquires, from the time stamp included in each piece of log information, the operating time of one of the specified devices that has transmitted the log information in the specified period. Then, when the acquired operating time of one of the specified devices is equal to or longer than a predetermined reference time (for example, two hours), the calculation unit 13 may adjust the coefficient associated with the specified device to zero.

By the fourth adjustment, when the operating time of one of the specified devices is equal to or longer than the reference time, the electric energy of the specified device to be reduced from the bulk electric energy becomes zero, and the electricity charge to be deducted becomes accordingly low. As a result, it is possible to prevent or reduce the chance of the consumer causing the specified device to operate for the reference time or longer.

Further, the calculation unit 13 may adjust, in accordance with the number of one or more previously designated electrical devices 42 and sensors 43 included in the specified devices, the coefficients associated with the specified devices. In the following description, the adjustment of the coefficients by the calculation unit 13 will be referred to as fifth adjustment.

For example, it is assumed that some of the electrical devices 42 whose device types are respective ones of air conditioner, television set, and refrigerator are previously designated. In this case, as the number of the electrical devices 42 which are included in the specified devices and whose device types are air conditioner, television set, or refrigerator is larger, the calculation unit 13 may adjust the coefficients associated with the electrical devices 42 whose device types are air conditioner, television set, or refrigerator to be larger.

By the fifth adjustment, as the number of one or more previously designated electrical devices 42 and sensors 43 included in the specified devices is larger, the electric energy to be reduced from the bulk electric energy becomes larger, and the reduced electricity charge to be deducted becomes higher. As a result, it is possible to prompt the consumer to preferentially cause the designated electrical device 42 and sensor 43 to operate. In addition, it is possible to prompt the consumer to purchase the designated electrical device 42 and sensor 43.

In addition, the calculation unit 13 may acquire the first information on the user of the specified devices and the second information representing the use history of the specified devices from the facility 4, and may adjust the coefficients associated with the specified devices on the basis of one or more of the following: an acquisition amount of the first information; an acquisition amount of the second information; a content of the first information; and a content of the second information. In the following description, the adjustment of the coefficients by the calculation unit 13 will be referred to as sixth adjustment.

Specifically, the calculation unit 13 may acquire, as the first information about the user of the specified devices, the personal information related to the consumer stored in the storage unit 15, and may adjust the coefficients associated with the specified devices to be larger as the acquisition amount of the first information is larger. The acquisition amount of the first information corresponds to the amount of information (data amount), stored in the storage unit 15, of personal information related to the consumer.

In addition, the calculation unit 13 may adjust the coefficients associated with the specified devices to be larger, assuming that the content of the acquired first information is more satisfactory as the number of information items included in the acquired first information is larger. Here, when the acquired first information includes identification information of the consumer and communication destination information, the number of information items included in the first information is determined to be two.

Further, the calculation unit 13 may request the log management server 3 to transmit the number of pieces of log information transmitted from the specified devices provided in the facility 4 of the consumer, and may acquire, as the information amount of the second information representing the use history of the specified devices, the number of pieces of log information returned from the log management server 3 in response to the request. Then, the calculation unit 13 may adjust the coefficients associated with the specified devices to be larger as the acquisition amount of the second information is larger.

Further, the calculation unit 13 may request the log management server 3 to transmit the number of information items included in the log information transmitted from the specified devices provided in the facility 4 of the consumer, and may acquire, as the content of the second information representing the use histories of the specified devices, the number of information items included in the log information returned from the log management server 3 in response to the request.

Then, the calculation unit 13 may adjust the coefficients associated with the specified devices to be larger, assuming that the content of the second information is more satisfactory as the number of the acquired information items is larger. Here, when the number of information items included in the log information transmitted by the electrical devices 42 as the specified devices is three and the number of information items included in the log information transmitted by the sensors 43 as the specified devices is two, the number of information items acquired by the calculation unit 13 is determined to be five.

By the sixth adjustment, as a consumer provides more information to the server 1 and the log management server 3, the electric energy to be reduced from the bulk electric energy becomes larger, and the electricity charge to be deducted becomes higher. As a result, it is possible to promote the consumer to provide a large amount of information to the server 1 and the log management server 3.

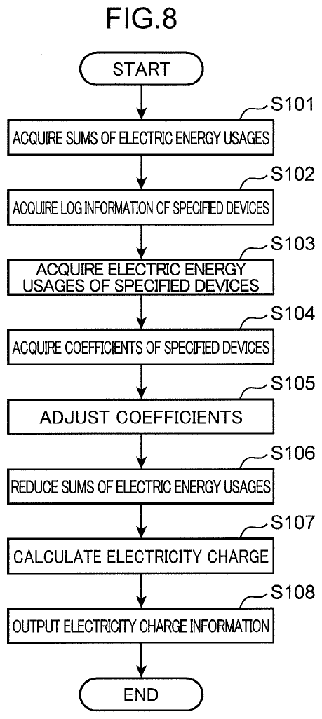

Next, a flow of an electricity charge output process in the electricity charge calculation system 100 will be described. FIG. 8 is a flowchart illustrating an example of an electricity charge output process. The electricity charge output process shown in FIG. 8 is performed every specified period described above.

In step S101, the first acquisition unit 11 acquires, for each of the one or more consecutive unit times T0 (FIG. 3) constituting the specified period T (FIG. 3), the sum (bulk electric energy) of the electric energy usages, for each unit time T0, of the one or more electrical devices 42 and the sensors 43 provided in the facility 4 of the consumer. That is, in step S101, the information represented by the graph G22 in FIG. 3 is acquired.

In step S102, the second acquisition unit 12 requests the log management server 3 to transmit the log information representing the operation state, in each unit time T0, of the specified devices for each of the one or more consecutive unit times T0 (FIG. 3) constituting the specified period T (FIG. 3), and the second acquisition unit 12 acquires the log information returned from the log management server 3.

In step S103, from the log information acquired in step S102, the second acquisition unit 12 acquires the electric energy usages, in each unit time T0 (FIG. 3), of the specified devices for each of the one or more consecutive unit times T0 (FIG. 3) constituting the specified period T (FIG. 3). That is, in step S103, information represented by the graphs G231 to G23N in FIG. 3 is acquired.

In step S104, the calculation unit 13 acquires the coefficients associated with the specified devices from the storage unit 15.

In step S105, the calculation unit 13 performs one or more of the above first to sixth adjustments to adjust the coefficients acquired in step S104 and associated with the specified devices. Note that step S105 may be omitted.

In step S106, the calculation unit 13 reduces, for each of the one or more consecutive unit times T0 (FIG. 3) constituting the specified period T (FIG. 3), the bulk electric energy for each unit time T0 (graph G22 in FIG. 3) acquired in step S101, in accordance with the electric energy usage of each specified device for each unit time T0 (graphs G231 to G23N in FIG. 3) acquired in step S103.

Specifically, in step S106, the calculation unit 13 calculates, for each of the one or more consecutive unit times T0 (FIG. 3) constituting the specified period T (FIG. 3), the products of the electric energy usage of each specified device for each unit time T0 (graphs G231 to G23N in FIG. 3) acquired in step S103 and one of the coefficients (graphs G241 to G24N in FIG. 3) that are associated with respective ones of the specified devices and are adjusted by step S105. Then, by the calculation unit 13, the products calculated for each unit time T0 are reduced from the bulk electric energy (graph G22) for each unit time T0 acquired in step S101.

In step S107, the calculation unit 13 calculates the electricity charge for the facility 4 in the specified period T (FIG. 3).

Specifically, in step S107, the calculation unit 13 requests the bulk electric power server 2 to transmit the unit charge information (graph G21 in FIG. 3) representing the unit charge for each time slot in the specified period T (FIG. 3), and the calculation unit 13 acquires the unit charge information returned from the bulk electric power server 2 in response to the request. Then, for each of the one or more consecutive unit times T0 (FIG. 3) constituting the specified period T (FIG. 3), the calculation unit 13 calculates, as the electricity charge for the facility 4 for each unit time T0 (FIG. 3), the product of the electric energy after the reduction in step S106 and the electricity charge (graph G21 in FIG. 3) per unit electric energy in the time slot including each unit time T0. Then, the calculation unit 13 calculates, as the electricity charge for the facility 4 in the specified period T (FIG. 3), the sum of the electricity charges calculated for respective ones of the one or more consecutive unit times T0 (FIG. 3) included in the specified period T (FIG. 3).

In step S108, the output unit 14 outputs electricity charge information, to be displayed on the display, representing the electricity charge for the facility 4 in the specified period T (FIG. 3) calculated in step S107. Specifically, in step S108, the output unit 14 controls the communication unit 16 and transmits the electricity charge information indicating the electricity charge for the facility 4 in the specified period T (FIG. 3) calculated in step S107 to the destination indicated by the communication destination information of the consumer stored in the storage unit 15, via the communication network 9.

The present disclosure can adopt the following modification examples.

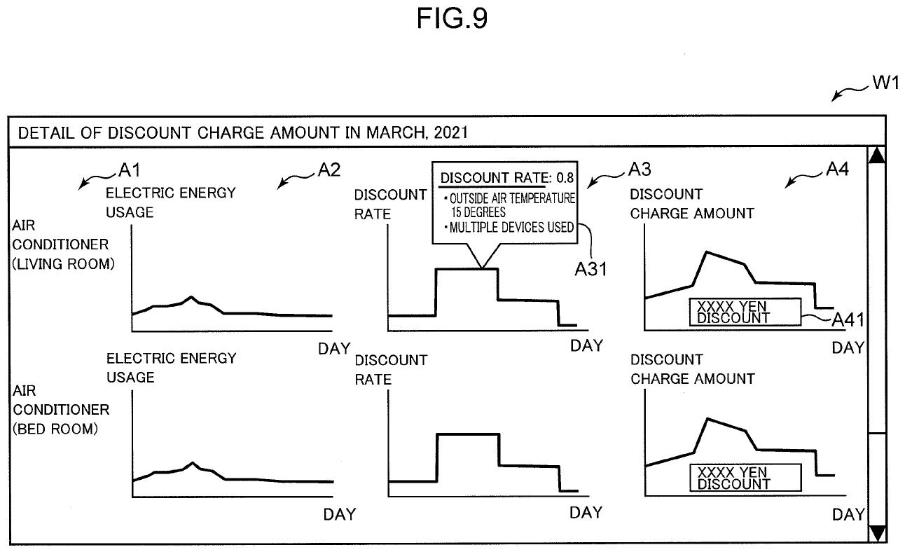

(1) FIG. 9 is a diagram illustrating an example of a discount detail screen W1. The output unit 14 may further output screen data, to be displayed on a display, of the discount detail screen W1 as illustrated in FIG. 9.

Specifically, as illustrated in FIG. 9, the discount detail screen W1 includes display fields A1 to A4. In the display field A1, identification information of the specified devices stored in the storage unit 15 is displayed. In the display field A2, there are displayed graphs representing the electric energy usages of respective ones of the specified devices for each unit time T0 in the specified period T, the electric energies each being acquired by the second acquisition unit 12 and corresponding to one of the graphs G231 to G23N in FIG. 3.

In the display field A3, there are displayed graphs, each corresponding to one of the graphs G241 to G24N in FIG. 3, representing the coefficients (time series changes in coefficient) for each unit time T0 in the specified period T, the coefficients each being associated with one of the specified devices and having been acquired and adjusted by the calculation unit 13.

When an operation of selecting a coefficient is performed on one of the graphs displayed in the display field A3, information A31 representing how the coefficient is determined is displayed in association with the selected coefficient. In the example of FIG. 9, the coefficient is displayed as “Discount rate”, and there are displayed, in association with the coefficient “0.8” indicated by the graph displayed in the display field A3, the information “Outside air temperature 15 degrees” and “Multiple devices used” showing that the first adjustment and the third adjustment are respectively performed to determine the coefficient.

Note that the information A31 representing how the coefficient is determined does not have to be displayed. Alternatively, the information representing how the coefficients are determined may always be displayed in association with respective ones of one or more coefficients represented by the graphs displayed in the display field A3.

In the display field A4, there are displayed discount charge amounts in accordance with the electric energy usages of respective ones of the specified devices for each unit time T0 in the specified period T. Specifically, in the display field A4 there are displayed the graphs representing the products, for each unit time T0 included in the specified period T, of the following values: the product of the electric energy usage of each specified device calculated by the calculation unit 13 for each unit time T0 (the electric energy usage corresponds to each of the graphs G231 to G23N in FIG. 3) and the coefficient that is acquired and adjusted by the calculation unit 13 and is associated with each specified device (the coefficient corresponds to each of the graphs G241 to G24N in FIG. 3); and the unit charge, in the time slot including each unit time T0, acquired by the calculation unit 13 (the unit charge corresponds to the graph G21 in FIG. 3).

In the display field A4, there is further displayed information A41 representing the sum of the discount charge amounts in accordance with the electric energy usage of each specified device for each unit time T0 in the specified period T, the sum being represented by each of the graphs displayed in the display field A4.

(2) One unit time T0 (FIG. 3) may be set to be the specified period T (FIG. 3), and the electricity charge output process illustrated in FIG. 8 may be performed every unit time T0 (FIG. 3). In accordance with this aspect, in step S108 (FIG. 8), the output unit 14 may further output information representing coefficients that are associated with the specified devices and are to be displayed on the display, in a similar manner to the case of the electricity charge information. As a result, the coefficients associated with the specified device may be updated every unit time T0 (FIG. 3), and the updated coefficients may be displayed on the display every unit time T0 (FIG. 3).

(3) Instead of steps S106 and S107 illustrated in FIG. 8, the calculation unit 13 may calculate the electricity charge for the facility 4 in the specified period T (FIG. 3) as follows.

Specifically, in a similar manner to step S106, the calculation unit 13 calculates, for each of the one or more consecutive unit times T0 (FIG. 3) constituting the specified period T (FIG. 3), the products of the electric energy usage of each of the first to Nth specified devices for each unit time T0 (FIG. 3) (graphs G231 to G23N in FIG. 3) acquired in step S103, and one of the coefficients (graphs G241 to G24N in FIG. 3) that are associated with respective ones of the first to Nth specified devices and are adjusted by step S105 (hereinafter, the products are referred to as a discount amount of electric energy).

Next, in a similar manner to step S107, the calculation unit 13 requests the bulk electric power server 2 to transmit the unit charge information (graph G21 in FIG. 3) representing the unit charge for each time slot in the specified period T (FIG. 3), and the calculation unit 13 acquires the unit charge information returned from the bulk electric power server 2 in response to the request. Then, for each of the one or more consecutive unit times T0 (FIG. 3) constituting the specified period T (FIG. 3), the calculation unit 13 calculates, as the discount charge amount for each unit time T0 (FIG. 3), the product of the discount amount of electric energy that is calculated for each unit time T0 and the electricity charge (graph G21 in FIG. 3) per unit electric energy in the time slot including each unit time T0.

Next, for each of the one or more consecutive unit times T0 (FIG. 3) constituting the specified period T (FIG. 3), the calculation unit 13 calculates, as a regular charge for each unit time T0 (FIG. 3), the product of the bulk electric energy for each unit time T0 (graph G22 in FIG. 3) acquired in step S101 and the electricity charge (graph G21 in FIG. 3) per unit electric energy in the time slot including each unit time T0.

Then, for each of the one or more consecutive unit times T0 (FIG. 3) constituting the specified period T (FIG. 3), the calculation unit 13 calculates, as the electricity charge for the facility 4 for each unit time T0 (FIG. 3), a charge obtained by reducing the discount charge amount for each unit time T0 (FIG. 3) from the regular charge for each unit time T0 (FIG. 3). Then, the calculation unit 13 calculates, as the electricity charge for the facility 4 in the specified period T (FIG. 3), the sum of the electricity charges calculated for respective ones of the unit times T0 (FIG. 3) included in the specified period T (FIG. 3).

With the present disclosure, it is possible to flexibly calculate an electricity charge in accordance with an electric energy usage of a specific device; therefore, the present disclosure is useful to provide a service in which an electricity charge can be flexibly set, in the electric retail business, in accordance with an electric energy usage of a specific electrical device.

1. An electricity charge output method comprising, by a computer:
acquiring a sum of electric energy usages, in a specified period, of a previously specified first device group among all devices provided at a facility and of a second device group that is among the all devices and is different from the first device group;
acquiring an electric energy usage of the first device group in the specified period;
reducing the sum in accordance with the electric energy usage of the first device group and calculating an electricity charge for the facility in the specified period, based on an electric energy after the reduction; and
outputting information representing the electricity charge for the facility.

2. The electricity charge output method according to claim 1, wherein
in the reducing the sum,
a product of the electric energy usage of the first device group and a coefficient previously associated with the first device group is reduced from the sum.

3. The electricity charge output method according to claim 2, wherein
the coefficient is determined depending on a type of the first device group.

4. The electricity charge output method according to claim 2, wherein
the coefficient is determined depending on an operation state of the first device group in the specified period.

5. The electricity charge output method according to claim 2, wherein
the first device group includes an air conditioner, and
the method further comprises, by the computer:
acquiring information representing outside air temperature in the specified period; and
adjusting the coefficient associated with the air conditioner in accordance with the acquired outside air temperature.

6. The electricity charge output method according to claim 2, further comprising, by the computer:
acquiring information representing whether there was a person in the specified period in a room in which the first device group is provided; and
adjusting the coefficient depending on whether the information representing that there was a person in the room has been acquired.

7. The electricity charge output method according to claim 2, further comprising, by the computer:
detecting whether a plurality of devices, of an identical type, included in the first device group simultaneously operated in the specified period; and
adjusting the coefficient associated with each of the plurality of devices of the identical type when detection is made that the plurality of devices of the identical type simultaneously operated.

8. The electricity charge output method according to claim 2, further comprising, by the computer:
acquiring information representing an operating time of the first device group in the specified period; and
adjusting the coefficient in accordance with the operating time.

9. The electricity charge output method according to claim 2, further comprising, by the computer,
adjusting the coefficient in accordance with a number of previously designated one or more devices included in the first device group.

10. The electricity charge output method according to claim 2, further comprising, by the computer:
acquiring, from the facility, first information on a user of the first device group and second information representing a use history of the first device group; and
adjusting the coefficient, based on one or more of an acquisition amount of the first information, an acquisition amount of the second information, a content of the first information, and a content of the second information.

11. The electricity charge output method according to claim 2, further comprising, by the computer,
outputting information representing the coefficient to be displayed on a display.

12. The electricity charge output method according to claim 2, further comprising, by the computer,
outputting information representing a time series change, in the coefficient, in the specified period to be displayed on a display.

13. The electricity charge output method according to claim 12, further comprising, by the computer,
outputting information representing how the coefficient is determined, the information being to be displayed on the display in association with the time series change in the coefficient.

14. An electricity charge output device comprising:
a first acquisition unit that acquires a sum of electric energy usages, in a specified period, of a previously specified first device group among all devices provided at a facility and of a second device group that is among the all devices and is different from the first device group;
a second acquisition unit that acquires an electric energy usage of the first device group in the specified period;
a calculation unit that reduces the sum in accordance with the electric energy usage of the first device group and calculates an electricity charge for the facility in the specified period, based on an electric energy after the reduction; and
an output unit that outputs information representing the electricity charge for the facility.

15. A non-transitory computer readable storage medium storing a program causing a computer to function as:
a first acquisition unit that acquires a sum of electric energy usages, in a specified period, of a previously specified first device group among all devices provided at a facility and of a second device group that is among the all devices and is different from the first device group;
a second acquisition unit that acquires an electric energy usage of the first device group in the specified period;
a calculation unit that reduces the sum in accordance with the electric energy usage of the first device group and calculates an electricity charge for the facility in the specified period, based on an electric energy after the reduction; and
an output unit that outputs information representing the electricity charge for the facility.
